(19) United States
(12) Patent Application Publication
(10) Pub. No.: US 2026/0188659 A1
(43) Pub. Date: Jul. 2, 2026

(54) CATHODE ACTIVE MATERIAL FOR LITHIUM SECONDARY BATTERY AND LITHIUM SECONDARY BATTERY INCLUDING THE SAME

(71) Applicants: SK ON CO., LTD., Seoul (KR); Industry-Academic Cooperation Foundation, Yonsei University, Seoul (KR)

(72) Inventors: Ju Sung HAN, Daejeon (KR); Myung Soo PARK, Daejeon (KR); Gun Young KIM, Daejeon (KR); Jeong Hun KIM, Seoul (KR); Hee Ji JEON, Seoul (KR); Min Seok JEONG, Seoul (KR); Seong Hyeon JUNG, Seoul (KR)

(21) Appl. No.: 19/433,987

(22) Filed: Dec. 29, 2025

(30) Foreign Application Priority Data
Dec. 27, 2024 (KR) 10-2024-0199227

(51) Int. Cl. H01M 4/36; H01M 4/02; H01M 4/525; H01M 4/60; H01M 10/052

(52) U.S. Cl. CPC H01M 4/366; H01M 4/525; H01M 4/604; H01M 10/052; H01M 2004/021; H01M 2004/028

(57) ABSTRACT

A cathode active material according to embodiments of the present disclosure includes lithium metal oxide particles and a conductive polymer coating layer doped with a dopant formed on the surface of the lithium metal oxide particles. The dopant is a copolymer including a first repeating unit and a second repeating unit. According to embodiments of the present disclosure, a lithium secondary battery including the above-described cathode active material may be provided.

### CROSS-REFERENCE TO RELATED APPLICATIONS

This application claims priority under 35 U.S.C. § 119 to Korean Patent Application No. 10-2024-0199227, filed on Dec. 27, 2024 in the Korean Intellectual Property Office (KIPO), the entire disclosures of which are incorporated by reference herein.

### BACKGROUND OF THE INVENTION

### 1. Field of the Invention

The present disclosure relates to a cathode active material for a lithium secondary battery, a cathode including the same, and a lithium secondary battery including the cathode.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery is actively developed and applied due to its high operating voltage, high energy density per unit weight, and advantages in charging speed and weight reduction.

The lithium secondary battery may include: an electrode assembly including a cathode, an anode, and a separator interposed between the cathode and the anode; and an electrolyte that impregnates the electrode assembly.

The cathode may include a cathode current collector and a cathode active material layer formed on the cathode current collector. For example, the cathode active material layer may include a cathode active material, a conductive material, a binder and the like.

Meanwhile, studies have been conducted on using conductive polymers as coating materials for cathode active materials; however, such methods have drawbacks, including active material fracture, side reactions with the electrolyte, and nickel elution, making them unsuitable as coating materials. In addition, when adhesive polymers are used as cathode active material coating materials, they lack conductivity, requiring the addition of conductive materials or other auxiliary materials.

Accordingly, to address these problems, research has been conducted to synthesize conductive polymers that possess both adhesion properties and high electrical conductivity.

### SUMMARY OF THE INVENTION

An object of the present disclosure is to provide a cathode active material for a lithium secondary battery with improved stability and enhanced electrolyte ion mobility.

Another object of the present disclosure is to provide a cathode for a lithium secondary battery and a lithium secondary battery having improved stability and high energy density.

A cathode active material for a lithium secondary battery according to the present disclosure includes lithium metal oxide particles, and a coating layer formed on at least a portion of the surface of the lithium metal oxide particles. The coating layer includes a conductive polymer doped with a dopant. The dopant is a copolymer comprising a first repeating unit including a sulfonate group; and a second repeating unit including at least one of a carboxyl group, a sulfonic acid group, or a phosphonic acid group.

According to some embodiments, the ratio of the molar amount of the second repeating unit to the molar amount of the first repeating unit may be 0.1 to 10.

According to some embodiments, the conductive polymer may include at least one selected from the group consisting of polythiophene-based polymers, polyaniline-based polymers, polystyrene-based polymers, polypyrrole-based polymers, polyacetylene-based polymers, polyazine-based polymers, polyphenylene-based polymers, and polyselenophene-based polymers.

According to some embodiments, the conductive polymer may include a polythiophene-based polymer.

According to some embodiments, the first repeating unit may include a repeating unit represented by Formula 3 below.

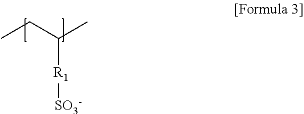

(in Formula 3, R₁ is an aromatic hydrocarbon group).

According to some embodiments, the second repeating unit may include a repeating unit represented by Formula 4 below.

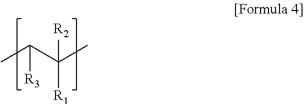

(in Formula 4, R₁ is a carboxyl group, a sulfonic acid group, or a phosphonic acid group, R₂ is hydrogen or an alkyl group having 1 to 5 carbon atoms, and R₃ is hydrogen or a carboxyl group).

According to some embodiments, the dopant has a weight average molecular weight of 10 kDa to 1 MDa.

According to some embodiments, the weight ratio of the conductive polymer to the dopant may be 1:0.1 to 1:10.

According to some embodiments, the coating layer may have a thickness of 500 nm or less.

According to some embodiments, the lithium metal oxide may be represented by Formula 1 below.

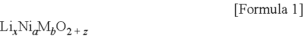

(in Formula 1, M includes at least one of Co, Mn and/or Al, and 0.9≤x≤1.2, 0.6≤a≤0.99, 0.01≤b≤0.4, and −0.5≤z≤0.1).

According to some embodiments, there is provided a cathode for a lithium secondary battery including the cathode active material.

According to some embodiments, there is provided a secondary battery including the cathode, an anode, and a separator interposed between the cathode and the anode.

The cathode active material for a lithium secondary battery according to some embodiments of the present disclosure includes a dopant and exhibits excellent adhesion properties, thereby preventing breakage of the cathode active material, suppressing side reactions with the electrolyte and metal dissolution, and improving battery stability.

The cathode active material for a lithium secondary battery according to some embodiments of the present disclosure exhibits excellent conductivity, thereby enhancing the mobility of electrolyte ions, minimizing the content of conductive material, increasing the amount of the cathode active material, and improving the energy density of the battery.

The cathode for a lithium secondary battery according to the present disclosure and the lithium secondary battery including the same may be widely applied in green technology fields, such as electric vehicles, battery charging stations, as well as solar power generation, wind power generation, and the like, which use the batteries. In addition, the cathode for a lithium secondary battery according to the present disclosure and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are schematic plan and cross-sectional views, respectively, illustrating a lithium secondary battery according to some embodiments.

### DETAILED DESCRIPTION OF THE INVENTION

Hereinafter, embodiments of the present disclosure will be described in detail. However, these are merely exemplary, and the present disclosure is not limited to the specific embodiments described herein.

According to embodiments of the present disclosure, there is provided a cathode active material for a lithium secondary battery including a coating layer containing a conductive polymer doped with a dopant. In addition, a cathode for a lithium secondary battery including the cathode active material and a lithium secondary battery including the cathode are provided.

In some embodiments, the cathode active material may include lithium (Li)-transition metal oxide particles. The lithium-transition metal oxide particles may further include at least one of cobalt (Co), manganese (Mn) and aluminum (Al). For example, the cathode active material may include a plurality of lithium-transition metal oxide particles.

In an embodiment, the cathode active material or the lithium-transition metal oxide particles may include a layered structure or a crystal structure represented by Formula 1 below.

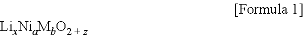

In Formula 1, x, a, b and z may satisfy 0.9≤x≤1.2, 0.6≤a≤0.99, 0.01≤b≤0.4, and 0.5≤z≤0.1. As described above, M may include Co, Mn and/or Al.

The chemical structure represented by Formula 1 indicates a bonding relationship among elements included in the layered structure or the crystal structure of the cathode active material or the lithium-transition metal oxide particles, and does not exclude the presence of additional elements. For example, M includes Co, Mn and/or Al, and Co, Mn and/or Al may be provided as main active elements of the cathode active material together with Ni. Here, it should be understood that Formula 1 is provided to express the bonding relationship between the main active elements, and is a formula encompassing the introduction and substitution of additional elements.

In an embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity/output activity of the cathode active material together with Co or Mn, such as Al.

In an embodiment, the lithium metal oxide may be a nickel-cobalt-manganese (NCM)-based lithium oxide. In this case, an NCM-based lithium oxide having an increased content of nickel may be used.

Nickel (Ni) may serve as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to some embodiments, by including Co, the cycle life stability and capacity retention properties may be improved by Mn, while electrical conductivity is maintained.

The content of Ni (e.g., the molar fraction of nickel based on the total molar amount of nickel, cobalt and manganese) in the NCM-based lithium oxide may be 0.5 or more, 0.6 or more, 0.7 or more, 0.8 or more, 0.9 or more, or 0.95 or more. In some embodiments, the content of Ni may be 0.8 to 0.98, 0.82 to 0.98, 0.83 to 0.98, 0.84 to 0.98, 0.85 to 0.98, 0.88 to 0.98, or 0.9 to 0.98.

In some embodiments, the ratio of the total molar amount of nickel in the lithium-transition metal oxide particles to the total molar amount of metals excluding lithium in the lithium-transition metal oxide particles may be 0.9 or more, and in an embodiment, 0.94 or more. Within this range, output performance and capacity properties may be improved.

In an embodiment, the lithium metal oxide may be represented by Formula 2 below.

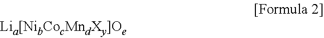

In Formula 2, X may include at least one of W, S, Al, Ti, Sr, Zr, P and K, and a, b, c, d, e and y may satisfy 0.5<a<1.5, 0.5≤b≤1, 0≤c<0.3, 0≤d<0.3, 1.5<e<2.5, and 0≤y<0.1.

In an embodiment, a conductive polymer coating layer may be formed on at least a portion of the surface of the lithium metal oxide particles. Accordingly, the conductivity of the cathode active material may be improved, and the energy density of the battery may be enhanced by reducing the content of the conductive material and increasing the content of the cathode active material.

In an embodiment, the conductive polymer may include at least one selected from the group consisting of a polythiophene-based polymer, a polyaniline-based polymer, a polystyrene-based polymer, a polypyrrole-based polymer, a polyacetylene-based polymer, a polyazine-based polymer, a polyphenylene-based polymer, and a polyselenophene-based polymer.

In an embodiment, the conductive polymer may include a polythiophene-based polymer.

In an embodiment, the conductive polymer may be doped with a dopant. Doping of the conductive polymer refers to the process of forming a salt between the conductive polymer and the dopant ion.

In some embodiments, the dopant may be a copolymer including a first repeating unit including a sulfonate group (—SO₃⁻) and a second repeating unit including at least one of a carboxyl group (—COOH), a sulfonic acid group (—SO₃H), or a phosphonic acid group (—H₂PO₃). Doping with the dopant may improve the adhesion properties of the cathode active material. Accordingly, fracture of the cathode active material may be prevented, and side reactions with the electrolyte and metal elution may be suppressed.

In an embodiment, the dopant may be an anionic dopant. The anionic dopant may be a copolymer including a first repeating unit and a second repeating unit.

In an embodiment, the first repeating unit may include a sulfonate group. By including the sulfonate group, it may provide an anion, enabling doping through ionic bonding with the conductive polymer.

In an embodiment, the first repeating unit may include a repeating unit represented by Formula 3 below.

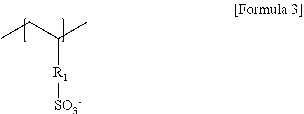

In Formula 3, R₁ may be an aromatic hydrocarbon group.

In an embodiment, the aromatic hydrocarbon group may be a substituted or unsubstituted aryl group having 6 to 12 carbon atoms, and the substituted aryl group may be an aryl group substituted with a halogen, an alkyl group having 1 to 5 carbon atoms, or an alkoxy group having 1 to 5 carbon atoms.

In an embodiment, R¹ may be a phenylene group.

In an embodiment, the second repeating unit may include at least one of a carboxyl group, a sulfonic acid group, or a phosphonic acid group. By including the carboxyl group, the sulfonic acid group, or the phosphonic acid group, it may contribute to doping and further enhance the mobility of electrolyte ions.

In an embodiment, the second repeating unit may include a repeating unit represented by Formula 4 below.

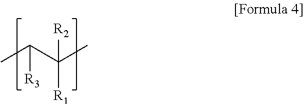

In Formula 4, R₁ may be a carboxyl group, a sulfonic acid group, or a phosphonic acid group, R₂ may be hydrogen or an alkyl group having 1 to 5 carbon atoms, and R₃ may be hydrogen or a carboxyl group.

In some embodiments, the ratio of the molar amount of the second repeating unit to the molar amount of the first repeating unit may be 0.1 to 10, for example, 0.2 to 8, 0.5 to 5, or 1 to 3. Within this molar ratio range, the doping ability of the dopant with respect to the conductive polymer may be improved.

In some embodiments, the dopant may have a weight average molecular weight (Mw) of 10 kDa to 1 MDa, for example, 50 kDa to 700 kDa, 100 kDa to 600 kDa, or 200 kDa to 500 kDa. Within this molecular weight range, the doping ability of the dopant with respect to the conductive polymer may be improved.

In some embodiments, the weight ratio of the conductive polymer to the dopant may be 1:0.1 to 1:10, for example, 1:0.2 to 1:8, 1:0.5 to 1:5, or 1:0.5 to 1:2. Within this range, the dopant may be effectively doped into the conductive polymer.

In some embodiments, the coating layer may have a thickness of 500 nm or less, for example, 300 nm or less, or 100 nm or less. Within this range, the coating ability for the cathode active material may be enhanced.

In some embodiments of the present disclosure, a cathode for a lithium secondary battery including the cathode active material for a lithium secondary battery and a lithium secondary battery including the cathode may be provided.

Hereinafter, embodiments of the disclosure will be described in more detail with reference to the accompanying drawings. However, the drawings attached to this specification illustrate some embodiments of the disclosure and serve to further enhance the understanding of the technical spirit of the disclosure together with the above-described disclosure. Therefore, the disclosure should not be construed as being limited to the matters illustrated in the drawings.

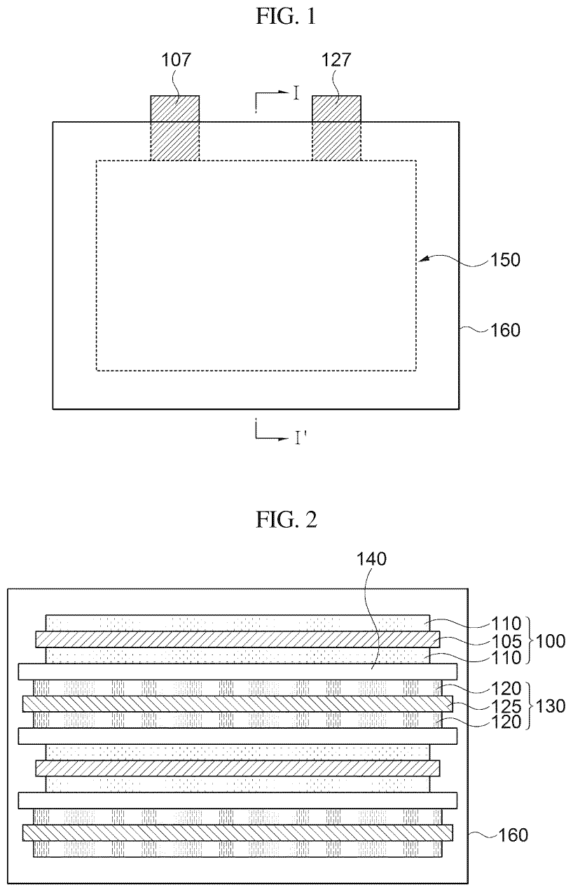

Referring to FIGS. 1 and 2, the lithium secondary battery may include a cathode 100 including the above-described cathode active material and an anode 130 disposed opposite the cathode 100.

The cathode 100 may include a cathode active material layer 110 formed by applying a cathode active material to at least one surface of a cathode current collector 105.

The cathode current collector 105 may include stainless steel, nickel, aluminum, titanium, or an alloy thereof. The cathode current collector 105 may also include aluminum or stainless steel having a surface treated with carbon, nickel, titanium or silver. For example, the cathode current collector 105 may have a thickness of 10 μm to 50 μm.

The cathode active material layer 110 may include the above-described cathode active material.

The cathode active material may be mixed in a solvent to prepare a cathode slurry. The cathode slurry may be coated on at least one surface of the cathode current collector 105, and then dried and roll-pressed to prepare the cathode active material layer 110. The coating may include processes such as gravure coating, slot die coating, simultaneous multilayer die coating, imprinting, doctor blade coating, dip coating, bar coating or casting, and the like. The cathode active material layer 110 may further include a binder, and optionally may further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In an embodiment, a PVDF-based binder may be used as the cathode binder. In this case, the amount of binder for forming the cathode active material layer 110 may be decreased and the amount of the cathode active material may be relatively increased. Accordingly, the output performance and capacity properties of the secondary battery may be improved.

The conductive material may be added to the cathode active material layer 110 in order to enhance the conductivity thereof and/or the mobility of lithium ions or electrons. For example, the conductive material may include carbon-based conductive materials such as graphite, carbon black, acetylene black, Ketjen black, graphene, vapor-grown carbon fibers (VGCF), carbon nanotubes (CNTs), or carbon fibers; and/or metal-based conductive materials such as tin, tin oxide, and titanium oxide; and perovskite materials such as LaSrCoO₃, and LaSrMnO₃. These may be used alone or in combination of two or more thereof.

The cathode slurry may further include a thickener and/or a dispersant. In an embodiment, the cathode slurry may include a thickener such as carboxymethyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with a conductive metal and the like. These may be used alone or in combination of two or more thereof. For example, the anode current collector 125 may have a thickness of 10 μm to 50 μm.

The anode active material layer 120 may include an anode active material. As the anode active material, a material capable of adsorbing and desorbing lithium ions may be used. For example, as the anode active material, carbon-based materials such as crystalline carbon, amorphous carbon, carbon composites, or carbon fibers, and the like; lithium metal; a lithium alloy; a silicon (Si)-containing material or a tin (Sn)-containing material, and the like may be used. These may be used alone or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In an embodiment, a lithium metal-containing layer deposited or coated on the anode current collector 125 may also be used as the anode active material layer 120. In an embodiment, a lithium thin-film layer may also be used as the anode active material layer 120.

Elements contained in the lithium alloy may include aluminum, zinc, bismuth, cadmium, antimony, silicon, lead, tin, gallium, indium, and the like. These may be used alone or in combination of two or more thereof.

The silicon-containing material may provide further enhanced capacity properties. The silicon-containing material may include Si, SiOₓ (0<x<2), metal-doped SiOₓ (0<x<2), a silicon-carbon composite, and the like.

The metal may include lithium and/or magnesium, and the metal-doped SiOₓ (0<x<2) may include a metal silicate.

The anode active material may be mixed in a solvent to prepare an anode slurry. The anode slurry may be coated or deposited on the anode current collector 125, and then dried and roll-pressed to prepare the anode active material layer 120. The coating may include processes such as gravure coating, slot die coating, simultaneous multilayer die coating, imprinting, doctor blade coating, dip coating, bar coating or casting, and the like. The anode active material layer 120 may further include a binder, and optionally may further include a conductive material, a thickener or the like.

The solvent included in the anode slurry may include water, purified water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder. These may be used alone or in combination of two or more thereof.

In some embodiments, a separator 140 may be interposed between the cathode 100 and the anode 130. The separator 140 may be configured to prevent an electrical short-circuit between the cathode 100 and the anode 130, and to allow the flow of ions. For example, the separator may have a thickness of 10μ m to 20μ m.

For example, the separator 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, and the like. These may be used alone or in combination of two or more thereof.

The porous nonwoven fabric may include glass fibers having a high melting point, polyethylene terephthalate fibers, and the like.

The separator 140 may also include a ceramic-based material. For example, inorganic particles may be coated on the polymer film or dispersed within the polymer film to improve heat resistance.

The separator 140 may have a single-layer or multi-layer structure including the above-described polymer film and/or non-woven fabric.

According to some embodiments, an electrode cell may be defined by the cathode 100, the anode 130 and the separator 140, and a plurality of electrode cells may be stacked to form, for example, a jelly roll type electrode assembly 150. For example, the electrode assembly 150 may be formed by winding, stacking, z-folding, or stack-folding the separator 140.

The electrode assembly 150 may be accommodated in a case 160 together with the electrolyte to define a lithium secondary battery. According to some embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻; Br⁻, I⁻, NO₃⁻, N(CN)₂⁻, BF₄⁻, ClO₄⁻, PF₆⁻, (CF₃)₂PF₄⁻, (CF₃⁻)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻; CF₃CO₂⁻, CH₃CO₂⁻, SCN⁻ and (CF₃CF₂SO₂)₂N⁻, and the like, may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, γ-butyrolactone, propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), and the like.

The fluorine-substituted carbonate compound may include fluoroethylene carbonate (FEC), and the like.

The sultone compound may include 1,3-propane sultone, 1,3-propene sultone, 1,4-butane sultone, and the like.

The cyclic sulfate compound may include 1,2-ethylene sulfate, 1,2-propylene sulfate, and the like

The cyclic sulfite compound may include ethylene sulfite, butylene sulfite, and the like.

The phosphate compound may include lithium difluoro bis(oxalato)phosphate, lithium difluorophosphate, and the like.

The borate compound may include lithium bis(oxalate)borate, and the like.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 100 and the anode 130 in place of the above-described separator 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₂—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), and the like. These may be used alone or in combination of two or more thereof.

In an embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, and the like.

As shown in FIGS. 1 and 2, electrode tabs (cathode tabs and anode tabs) may protrude from the cathode current collector 105 and the anode current collector 125, respectively, which belong to respective electrode cells, and may extend to one side of the case 160. The electrode tabs may be fused or welded together with the one side of the case 160 to form electrode leads (a cathode lead 107 and an anode lead 127) that extend or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### (1) Preparation of Dopant

A dopant copolymer was prepared according to Scheme 1 below.

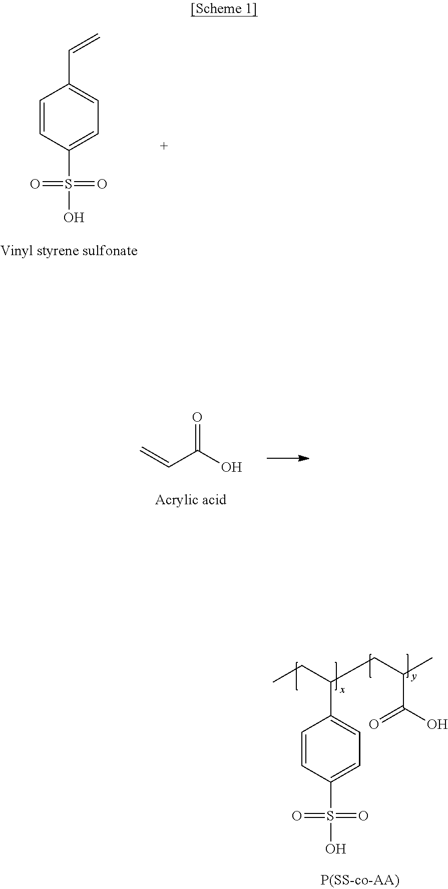

Vinyl styrene sulfonate and acrylic acid were respectively added and mixed in distilled water from which dissolved oxygen had been removed by bubbling N₂ for 1 hour to prepare a mixed solution. The mixed solution was introduced into a reactor maintained at 80° C., and a coprecipitation reaction was performed for 12 hours using persulfate as an initiator to obtain P(SS-co-AA). The reaction was conducted under atmospheric pressure.

In this case, the molar ratio of styrene sulfonate as the first repeating unit to acrylic acid as the second repeating unit, and the weight average molecular weight of the prepared P(SS-co-AA) are shown in Table 1 below.

### (2) Preparation of Dopant-Doped Conductive Polymer Binder

A dopant-doped conductive polymer coating layer was prepared as shown in Scheme 2 below.

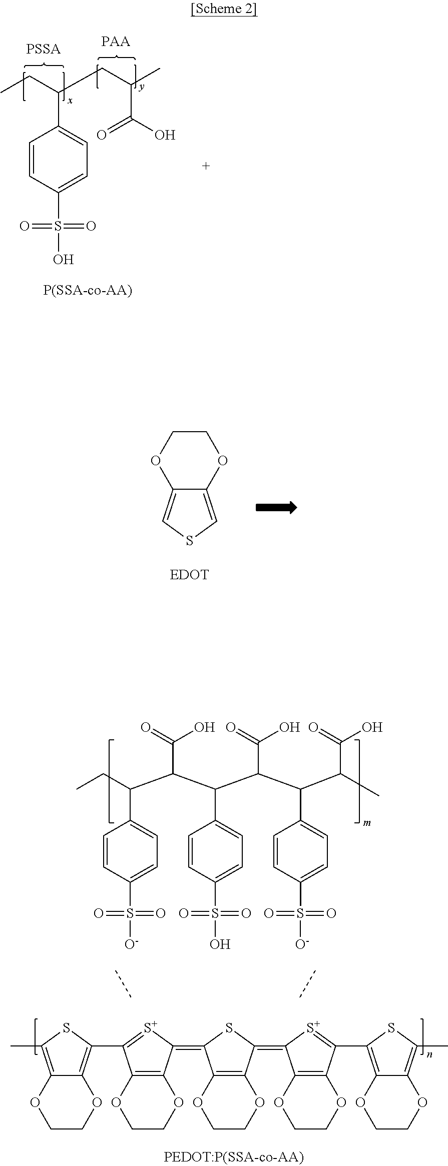

P(SS-co-AA) and EDOT were respectively added and mixed in distilled water from which dissolved oxygen had been removed by bubbling N₂ for 1 hour to prepare a mixed solution. The mixed solution was introduced into a reactor maintained at 25° C., and a coprecipitation reaction was performed for 24 hours using persulfate as an initiator to obtain PEDOT:P (SS-co-AA). The reaction was conducted under atmospheric pressure.

In this case, the ratio of the dopant to the conductive polymer is shown in Table 1.

### (3) Preparation of Lithium-Transition Metal Oxide Particles

NiSO₄, CoSO₄, and MnSO₄ were added and mixed in distilled water from which dissolved oxygen had been removed by bubbling N₂ for 24 hours at a molar ratio of 94:5:1 to prepare a mixed solution. The mixed solution was introduced into a reactor maintained at 50° C., and a coprecipitation reaction was performed for 72 hours using NaOH and NH₃H₂O as a precipitant and a chelating agent to obtain Ni_{0.94}Co_{0.05}Mn_{0.01}(OH)₂ as a transition metal precursor. The transition metal precursor was dried at 100° C. for 12 hours and further dried at 120° C. for 10 hours.

Lithium hydroxide and the transition metal precursor were added to a dry high-speed mixer at a ratio of 1.03:1 and uniformly mixed for 20 minutes. The mixture was placed in a calcination furnace, heated to 850° C. at a heating rate of 2° C./min, and calcined at 850° C. for 12 hours. During heating and calcination, oxygen gas was continuously supplied at a flow rate of 10 mL/min. After completion of the calcination, the product was naturally cooled to room temperature, pulverized, and classified to prepare lithium-transition metal oxide particles (LiNi_{0.94}Co_{0.03}Mn_{0.03}O₂) having a single particle form.

After preparing the lithium-transition metal oxide particles, a dopant-doped conductive polymer coating layer was spray-coated onto the lithium-transition metal oxide particles using a spray-coating technique. A spray dryer was used, and the process was conducted for about 20 minutes per 100 g of material.

### (4) Manufacture of Lithium Secondary Battery

A lithium secondary battery was manufactured using the lithium-transition metal oxide particles as a cathode active material.

Specifically, the cathode active material, Denka Black and CNTs as conductive materials, and PVDF as a binder were mixed at a mass ratio of 97.7:0.5:0.5:1.3 to prepare a cathode slurry. The cathode slurry was then applied to an aluminum current collector, and then dried and roll-pressed to fabricate a cathode.

An anode slurry, which includes 93 wt % of artificial graphite as an anode active material, 5 wt % of KS6 as a flake type conductive material, 1 wt % of styrene-butadiene rubber (SBR) as a binder, and 1 wt % of carboxymethyl cellulose (CMC) as a thickener, was prepared. The anode slurry was applied to a copper substrate, and then dried and roll-pressed to fabricate an anode.

Fourteen cathodes and fifteen anodes were notched into a predetermined size and stacked, then an electrode cell was fabricated by interposing a separator (polyethylene, thickness: 25 μm) between the cathode and the anode. Thereafter, tab parts of the cathode and the anode were welded, respectively. The assembly of the welded cathode/separator/anode was placed into a pouch, and three sides of the pouch were sealed, leaving one side open for electrolyte injection. At this time, a portion having the electrode tab was included in the sealed part. After injecting the electrolyte through the electrolyte injection side, the remaining electrolyte injection side was also sealed, and the cell was left to be impregnated for 12 hours or more.

A solution, prepared by dissolving a 1M LiPF₆ solution in a mixed solvent of EC/EMC (25/75; volume ratio), and further adding 1 wt % of vinylene carbonate (VC), and 0.5 wt % of 1,3-propenesultone (PRS) based on the total weight of the solution, was used as the electrolyte.

Then, pre-charging was conducted on the secondary battery manufactured as described above with a current (5A) corresponding to 0.25 C for 36 minutes. After 1 hour, degassing was performed, then aging for 24 hours or more was conducted, followed by performing formation charging-discharging (charging conditions: CC-CV 0.2 C, 4.2 V, 0.05 C cut-off; discharging conditions: CC 0.2 C, 2.5 V cut-off).

### Examples 2 to 8 and Comparative Examples 1 to 2

Cathode active material coatings and lithium secondary batteries were manufactured in the same manner as in Example 1, except that the types of the first and second repeating units, the molar ratio between the repeating units of the dopant, and the weight ratio of the dopant and the conductive polymer were changed, as shown in Table 1 below.

TABLE 1

| | | | Molar ratio of | Weight ratio of | Weight average |
|---|---|---|---|---|---|
| | | | first repeating | dopant:conductive | molecular weight |
| | Type of first | Type of second | unit:second | polymer | of dopant |
| | repeating unit | repeating unit | repeating unit | (EDOT) | (g/mol) |
| Example 1 | Styrene | Acrylic acid | 2:1 | 1:1 | 102,431 |
| | sulfonate | | | | |
| Example 2 | Styrene | Acrylic acid | 1:1 | 1:1 | 153,100 |
| | sulfonate | | | | |
| Example 3 | Styrene | Acrylic acid | 1:2 | 1:1 | 182,300 |
| | sulfonate | | | | |
| Example 4 | Styrene | Acrylic acid | 1:1 | 1:2 | 175,724 |
| | sulfonate | | | | |
| Example 5 | Styrene | Acrylic acid | 1:1 | 2:1 | 167,344 |
| | sulfonate | | | | |
| Example 6 | Styrene | Phosphonic | 1:1 | 1:1 | 127.711 |
| | sulfonate | acid | | | |
| Example 7 | Styrene | Phosphonic | 3:1 | 1:1 | 155,222 |
| | sulfonate | acid | | | |
| Example 8 | Styrene | Phosphonic | 5:1 | 1:1 | 139,248 |
| | sulfonate | acid | | | |
| Comparative | — | — | — | Use only | — |
| Example 1 | | | | PEDOT | |
| Comparative | Styrene | — | — | — | 110.492 |
| Example 2 | | | | | |

### Experimental Example

### (1) Evaluation of Electrical Conductivity

The electrical conductivity of the lithium secondary batteries of the examples and comparative examples described above was measured using a powder resistance measuring device (MCP-PD51, Nittoseiko Analytech Co.).

Specifically, a 2 g sample of cathode active material was pressed to a density of about 2.0 g/cc, and the resistance and electrical conductivity of the sample were measured.

The analysis conditions were as follows.

Start lane: 1 Ω

Voltage limiter: 10 V

Probe: 4-pin probe (electrode distance: 3.0 mm/electrode radius: 0.7 mm/sample radius: 10.0 mm)

(2) Evaluation of Capacity Retention (Energy Density: 710 mWh/g)

Charging (CC-CV 0.5 C, 3.8 V, 0.05 C cut-off) and discharging (CC 0.5 C, 2.5 V cut-off) were repeated 60 times on the above-described lithium secondary batteries of the examples and comparative examples at room temperature (25° C.). The discharge capacity at the 60th cycle was divided by the discharge capacity at the first cycle and multiplied by 100 to evaluate the capacity retention.

The evaluation results for the electrical conductivity and capacity retention of the examples and comparative examples are shown in Table 2.

TABLE 2

| | Electrical | Capacity |
|---|---|---|
| | conductivity (S/cm) | retention (%) |
| Example 1 | 440 | 58 |
| Example 2 | 380 | 53 |
| Example 3 | 250 | 47 |
| Example 4 | 260 | 54 |
| Example 5 | 450 | 56 |
| Example 6 | 45 | 37 |
| Example 7 | 48 | 31 |
| Example 8 | 108 | 23 |
| Comparative Example 1 | 0.1 | 0 |
| Comparative Example 2 | 0 | 0 |

Referring to Table 2, the examples exhibited superior electrical conductivity and enhanced adhesion to the cathode active material compared with the comparative examples. Accordingly, the electrochemical performance and capacity retention of the batteries were improved.

The contents described above are merely examples of applying the principles of the present disclosure, and other configurations may be further included without departing from the scope of the present disclosure.

What is claimed is:

1. A cathode active material for a lithium secondary battery, comprising:
lithium metal oxide particles; and
a coating layer formed on at least a portion of the surface of the lithium metal oxide particles,
wherein the coating layer comprises a conductive polymer doped with a dopant, and
the dopant is a copolymer comprising a first repeating unit including a sulfonate group; and a second repeating unit including at least one of a carboxyl group, a sulfonic acid group, or a phosphonic acid group.

2. The cathode active material for a lithium secondary battery according to claim 1, wherein the ratio of the molar amount of the second repeating unit to the molar amount of the first repeating unit is 0.1 to 10.

3. The cathode active material for a lithium secondary battery according to claim 1, wherein the conductive polymer comprises at least one selected from the group consisting of polythiophene-based polymers, polyaniline-based polymers, polystyrene-based polymers, polypyrrole-based polymers, polyacetylene-based polymers, polyazine-based polymers, polyphenylene-based polymers, and polyselenophene-based polymers.

4. The cathode active material for a lithium secondary battery according to claim 1, wherein the conductive polymer comprises a polythiophene-based polymer.

5. The cathode active material for a lithium secondary battery according to claim 1, wherein the first repeating unit includes a repeating unit represented by Formula 3 below, 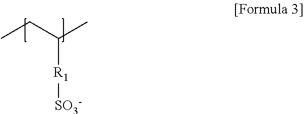
(in Formula 3, R₁ is an aromatic hydrocarbon group).

6. The cathode active material for a lithium secondary battery according to claim 1, wherein the second repeating unit includes a repeating unit represented by Formula 4 below, 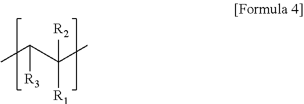
(in Formula 4, R₁ is a carboxyl group, a sulfonic acid group, or a phosphonic acid group, R₂ is hydrogen or an alkyl group having 1 to 5 carbon atoms, and R₃ is hydrogen or a carboxyl group).

7. The cathode active material for a lithium secondary battery according to claim 1, wherein the dopant has a weight average molecular weight of 10 kDa to 1 MDa.

8. The cathode active material for a lithium secondary battery according to claim 1, wherein the weight ratio of the conductive polymer to the dopant is 1:0.1 to 1:10.

9. The cathode active material for a lithium secondary battery according to claim 1, wherein the coating layer has a thickness of 500 nm or less.

10. The cathode active material for a lithium secondary battery according to claim 1, wherein the lithium metal oxide is represented by Formula 1 below, 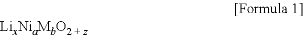
(in Formula 1, M includes at least one of Co, Mn and/or Al, and 0.9≤x≤1.2, 0.6≤a≤0.99, 0.01≤b≤0.4, and −0.5≤z≤0.1).

11. A cathode for a lithium secondary battery comprising the cathode active material according to claim 1.

12. A secondary battery comprising:
the cathode according to claim 11;
an anode; and
a separator interposed between the cathode and the anode.
